(19) United States
(12) Patent Application Publication
(10) Pub. No.: US 2016/0041132 A1
(43) Pub. Date: Feb. 11, 2016

(54) FINGERPRINTING FOR GAS LIFT DIAGNOSTICS

(71) Applicants: Michael C. Romer, The Woodlands, TX (US); Ted A. Long, Spring, TX (US); Michael K. Johnson, Spring, TX (US)

(72) Inventors: Michael C. Romer, The Woodlands, TX (US); Ted A. Long, Spring, TX (US); Michael K. Johnson, Spring, TX (US)

(21) Appl. No.: 14/796,850

(22) Filed: Jul. 10, 2015

Related U.S. Application Data
(60) Provisional application No. 62/035,287, filed on Aug. 8, 2014.

(51) Int. Cl. G01N 30/72; H01J 49/00; E21B 47/00

(52) U.S. Cl. CPC G01N 30/72; E21B 47/0007; H01J 49/0027; G01N 2030/025

(57) ABSTRACT

Method for determining the depth of entry of lift gas into a production tube of a gas lift well includes the step of determining the concentration of GCOI endogenous to formation gas produced from the production tube of a gas lift well and absent from gas used as the lift gas in said gas lift well versus time after a perturbation of the rate of introduction of said lift gas into said production tube via one or more gas lift valves. The invention includes a system configured for evaluating the performance of gas lift well, including a separator, a flow regulation device, a measurement device for measuring over time the concentration of a GCOI in production fluids, a data collection and storage device for recording data from the measurement device, and a computer program product embodied on a computer-readable medium for analyzing the data collected by the measuring device.

### CROSS-REFERENCE TO RELATED APPLICATION

This application claims the benefit of U.S. Provisional Patent Application 62/035,287, filed Aug. 8, 2014, entitled “Fingerprinting For Gas Lift Diagnostics,” the entirety of which is incorporated by reference herein.

### FIELD OF THE INVENTION

The invention relates to methods for monitoring performance of gas lifting in oil and gas production wells and diagnosis and characterization of suboptimal performance.

### BACKGROUND OF THE INVENTION

“Artificial lift” is a technique used in oil and gas production that refers to methods used to transport produced fluids to the surface when reservoir pressure alone is insufficient. Gas lift is a common method that is particularly suited to high-volume offshore wells. A production well will typically include a production tube located within a casing annulus surrounding the production tube. Gas lift valves connecting the annulus to the production tube are placed at intervals of depth. A high pressure (up to several thousand psi) gas is injected into the casing annulus of the production well and travels to a gas lift valve. An open gas lift valve provides a pathway for a designed volume of lift gas to enter the production tube. The lift gas reduces the density of the fluid column in the production tube, decreasing backpressure on the producing formation. The available reservoir pressure can then force more fluid to the surface. Gas lift valves are effectively pressure regulators and are typically installed during well completion. Multiple gas lift valves may be installed.

Gas lift is effective and gas lift wells are low maintenance. However, a problem with the technology is that gas lift wells still produce substantially even when they are not optimized. Wells will typically still flow—albeit at a reduced production rate—even if they are receiving too much (or too little) lift gas and/or are lifting from multiple valves or a valve above the desired operating point. Field diagnostics and modeling have estimated that less than 25% of gas lift wells are optimized, resulting in lost production and inefficient allocation of lift gas.

A relatively recent commercially available gas lift diagnostic technique is CO₂ tracing. A liquid slug of CO₂ (or possibly another tracer) is injected into the lift gas and detected when it returns to surface with a gas chromatograph. The gas and liquid injection/production transit times are calculated and used to determine which valves are passing gas. This information is then used to determine if the well is lifting from an optimal depth and/or if any valves need replacement. A drawback of CO₂ or nitrogen injection tracing is that the measurement equipment is bulky and multiple CO₂ and N₂ bottles are required for tracing and pressurization, making logistics difficult—especially in remote areas. Deep wells, or wells with small gas lift injection volumes can take hours to diagnose. Uncertainty in the gas lift injection rate can cloud results. Additionally, an open upper valve can take most of the injected slug, masking lower valves. The information CO₂ injection tracing technology provides is invaluable; the present invention improves significantly upon this technology.

### SUMMARY OF THE INVENTION

In one aspect, disclosed herein is a method for determining the depth of entry of lift gas into a production tube of a gas lift well, the gas lift well including a casing annulus including a lift gas, one or more production tubes including production fluids and surrounded by the casing annulus, and gas lift valves providing for entry of lift gas from the annulus to the production tube(s), comprising determining the concentration of a gaseous component(s) of interest (GCOI) endogenous to a formation gas produced from the production tube of a gas lift well and absent from gas used as the lift gas in said gas lift well versus time after a perturbation of the rate of introduction of said lift gas into said production tube via one or more gas lift valves.

In some embodiments, the GCOI is H₂S, nitrogen, carbon dioxide, methane, ethane or propane.

In some embodiments, the GCOI is a panel of components of interest (POCI), and the POCI is a mixture of hydrogen sulfide and at least one of methane, ethane or propane.

In some embodiments, the POCI is a mixture of hydrogen sulfide and carbon dioxide or nitrogen, or a mixture of hydrogen sulfide, carbon dioxide and nitrogen.

In some embodiments, the perturbation is an increase in the rate of introduction of lift gas into the production tube. In some embodiments, the perturbation is a decrease in the rate of introduction of lift gas into the production tube.

In some embodiments, the GCOI concentration is measured by gas chromatography, mass spectroscopy or gas chromatography/mass spectroscopy.

In some embodiments, the method includes a step of measuring the amount of GCOI in the formation gas and in the lift gas prior to perturbing the rate of introduction of lift gas into the production tube.

In another aspect, disclosed herein is a method for determining in a gas lift well, the gas lift well including a casing annulus including a lift gas, one or more production tubes including production fluids and surrounded by the casing annulus, and gas lift valves providing for entry of lift gas from the annulus to the production tube(s), the presence of a leak between the production tube and the annulus, comprising: i) determining at a depth d₀ the concentration of a GCOI in fluids produced from the production tube of a gas lift well, said GCOI being endogenous to a gas present in a formation tapped by said gas lift well and absent from gas used as the lift gas in said gas lift well, versus time after a perturbation of the rate of introduction of said lift gas into said production tube via a gas lift valve located at a depth d₁ to measure a time t₁ when the concentration of GCOI changes from the concentration before the perturbation; ii) comparing the time t₁ with the time t₀ obtained by calculation of the time expected for a unit of gas volume to move from depth d₁ to depth d₀; wherein t₁<t₀ indicates a leak between the production tube and the annulus at some depth above d₁.

In some embodiments, the GCOI is H₂S, nitrogen, carbon dioxide, methane, ethane or propane.

In some embodiments, the GCOI is a POCI, and the POCI is a mixture of hydrogen sulfide and at least one of methane, ethane or propane.

In some embodiments, the POCI is a mixture of hydrogen sulfide and carbon dioxide or nitrogen, or a mixture of hydrogen sulfide, carbon dioxide and nitrogen.

In some embodiments, the perturbation is an increase in the rate of introduction of lift gas into the production tube. In some embodiments, the perturbation is a decrease in the rate of introduction of lift gas into the production tube.

In some embodiments, the GCOI concentration is measured by gas chromatography, mass spectroscopy or gas chromatography/mass spectroscopy.

In some embodiments, the method includes a step of measuring the amount of GCOI in the formation gas and in the lift gas prior to perturbing the rate of introduction of lift gas into the production tube.

In yet another aspect, disclosed herein is a method for determining in a gas lift well, the gas lift well including a casing annulus including a lift gas, one or more production tubes including production fluids and surrounded by the casing annulus, and gas lift valves providing for entry of lift gas from the annulus to the production tube(s), the presence or absence of a leak between the annulus and the borehole or formation, comprising: i) determining at a depth d0 the concentration of a GCOI in fluids produced from the production tube of said gas lift well, said GCOI being endogenous to a gas present in a formation tapped by said gas lift well and absent from gas used as the lift gas in said gas lift well, versus time after a perturbation of the rate of introduction of said lift gas into said production tube via a gas lift valve, to measure a maximum change in concentration ΔCmax of said GCOI over the interval from the time of the perturbation to a time t₁ that is the expected time of transit of a unit volume of gas from said gas lift valve to depth d₀; ii) comparing the value of ΔCmax measured to the ΔCmax expected as calculated by the change in the amount of lift gas introduced into the production tube in said perturbation, wherein a value of measured ΔCmax below the expected value of ΔCmax indicates the presence of a leak of lift gas from the annulus to the borehole or formation.

In some embodiments, the GCOI is H₂S, nitrogen, carbon dioxide, methane, ethane or propane.

In some embodiments, the GCOI is a POCI, and the POCI is a mixture of hydrogen sulfide and at least one of methane, ethane or propane.

In some embodiments, the POCI is a mixture of hydrogen sulfide and carbon dioxide or nitrogen, or a mixture of hydrogen sulfide, carbon dioxide and nitrogen.

In some embodiments, the perturbation is an increase in the rate of introduction of lift gas into the production tube.

In some embodiments, the perturbation is a decrease in the rate of introduction of lift gas into the production tube.

In some embodiments, the GCOI concentration is measured by gas chromatography, mass spectroscopy or gas chromatography/mass spectroscopy.

In some embodiments, the method includes the step of measuring the amount of GCOI in the formation gas and in the lift gas prior to perturbing the rate of introduction of lift gas into the production tube.

In still yet another aspect, disclosed herein is a system for evaluating the performance of a gas lift well, the gas lift well including an annulus, one or more production tubes, and one or more gas lift valves connecting the annulus and the one or more production tubes, said system comprising a separator, a flow regulation device, a measurement device for measuring over time the concentration of a GCOI in production fluids, a data collection and storage device for recording data from the measurement device, and a computer program product embodied on a computer-readable medium for analyzing the data collected by the measuring device.

In some embodiments, the measurement device is a mass spectrometer. In some embodiments, the measurement device is a tandem mass spectrometer.

In some embodiments, the measurement device is programmed to detect and quantitate concentrations of at least one of H₂S, nitrogen, carbon dioxide, methane, ethane or propane. In some embodiments, the measurement device is programmed to detect and quantitate concentrations of a mixture of hydrogen sulfide and carbon dioxide or nitrogen, or a mixture of hydrogen sulfide, carbon dioxide and nitrogen.

In some embodiments, the system includes a pressure sensor for measuring the pressure of lift gas injected into the annulus of the gas lift well and wherein the data collection and storage device can be triggered to begin data collection upon sensing a predetermined change in pressure of lift gas injection.

In a further aspect, disclosed herein is a non-volatile computer readable medium comprising instructions for specifically programming a computer to: i) instruct a data collection and storage device to collect data of concentration of a GCOI in production fluids collected from the production tubing of a gas lift well, under a condition of a first lift gas injection pressure; ii) collect data of concentration of a GCOI in production fluids collected from the production tubing of said gas lift well over time after a time t₀ at which the pressure of injection of lift gas into said annulus of the gas lift well is changed; iii) display the data collected in ii) as a plot of GCOI concentration vs. time or as a table of GCOI concentration vs. time.

In some embodiments, the non-volatile computer readable medium includes: iv) instructions to calculate the velocity of fluids in the production tubing of said gas lift well; v) data of the depth of said one or more gas lift valves in the gas lift well; vi) instructions for displaying the time of transit of production fluids from the depth of said one or more gas lift valves to the site of said data collection and storage device on the plot of GCOI concentration vs. time or in the table of GCOI concentration vs. time.

### BRIEF DESCRIPTION OF THE DRAWINGS

The embodiments disclosed herein are illustrated by way of example, and not by way of limitation, in the figures of the accompanying drawings and in which like reference numerals refer to similar elements and in which:

FIG. 1 is a schematic drawing of a gas lift well showing gas inlet/outlet points.

FIG. 2 is an example plot of GCOI concentration over time during a fingerprinting diagnostic test.

FIG. 3A is an illustration of a leak scenario (“scenario 1”) detectable by the invention in which a leak between the production tube and the casing annulus is present below the working gas lift valve. FIG. 3B is an illustration of a GCOI concentration profile vs. time after perturbation that is suggestive of the scenario 1 shown in FIG. 3A.

FIG. 4A is an illustration of a leak scenario (“scenario 2”) detectable by the invention in which a leak between the production tube and the casing annulus is present above the working gas lift valve. FIG. 4B is an illustration of a GCOI concentration profile vs. time after perturbation that is suggestive of the scenario 2 shown in FIG. 4A.

FIG. 5A is an illustration of a leak scenario (“scenario 3”) detectable by the invention in which a leak between the casing annulus and the borehole is present above the working gas lift valve. FIG. 5B is an illustration of a GCOI concentration profile vs. time after perturbation that is suggestive of the scenario 3 shown in FIG. 5A.

FIG. 6A is an illustration of a leak scenario (“scenario 4”) detectable by the invention in which a leak between the production tube and the casing annulus is present below the working gas lift valve and a leaking gas lift valve is above the working gas lift valve. FIG. 6B is an illustration of a GCOI concentration profile vs. time after perturbation that is suggestive of the scenario 4 shown in FIG. 6A.

FIG. 7A is an illustration of a leak scenario (“scenario 5”) detectable by the invention in which a leak between the production tube and the casing annulus and a leaking gas lift valve are both present above the working gas lift valve. FIG. 7B is an illustration of a GCOI concentration profile vs. time after perturbation that is suggestive of the scenario 5 shown in FIG. 7A.

FIG. 8 depicts a gas lift well surveillance kit 10 in accordance with one or more embodiments of the invention.

### DESCRIPTION OF THE PREFERRED EMBODIMENTS

Various aspects will now be described with reference to specific embodiments selected for purposes of illustration. It will be appreciated that the spirit and scope of the apparatus, system and methods disclosed herein are not limited to the selected embodiments. Moreover, it is to be noted that the figures provided herein are not drawn to any particular proportion or scale, and that many variations can be made to the illustrated embodiments.

Each of the following terms written in singular grammatical form: “a,” “an,” and “the,” as used herein, may also refer to, and encompass, a plurality of the stated entity or object, unless otherwise specifically defined or stated herein, or, unless the context clearly dictates otherwise. For example, the phrases “a device,” “an assembly,” “a mechanism,” “a component,” and “an element,” as used herein, may also refer to, and encompass, a plurality of devices, a plurality of assemblies, a plurality of mechanisms, a plurality of components, and a plurality of elements, respectively.

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the embodiments disclosed herein, and is not to be understood or construed as inflexibly limiting the scope of the embodiments disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

Inline fingerprinting technology can replace CO₂ or N₂ tracer technology in certain applications. The composition of gas lift injection gas is typically different from that of formation gas as certain components such as helium, H₂S, CO₂, or heavier hydrocarbons are removed before compression. Also gases that provide a saleable product, such as methane, ethane, propane(s), butanes and pentanes, might be removed from the formation gas before it is then recycled as lifting gas. Gases native to formations and used as lift gas can differ among locations.

Differences between gases produced from the formation and gases used as the lift gas can be used to determine which valves are being lifted through. A composition measurement (fingerprinting) device/technique such as a gas chromatograph, mass spectrometer, spectroscopic or electrical analysis, etc. can be used to fingerprint the gas lift injection gas and the formation gas to identify components in produced formation gas that are not present in the lift gas. The instrument is then used to fingerprint the mixture of formation plus gas lift gas being produced. A system upset is made, such as temporarily increasing or decreasing the injected gas lift gas rate. One or more of the components of the formation gas that differentiate the injected and formation gases are monitored for their concentration in the production fluids. The change in concentration of the one or more components combined with estimated tubing liquid/gas transit times is used to determine which gas lift valves admit gas to the production tube and to detect leaks in the system.

The present invention improves upon CO₂ injection tracing and other gas lift monitoring methods that rely upon injection of a tracer at the surface. The principal improvements arise from monitoring of one or more gaseous component(s) of interest (“GCOI”) that is/are endogenous to the formation gas, i.e. present in the formation gas and liquid mixture that is being produced from the gas lift well, but absent from the lift gas injected into the annulus at the surface. Preferably, a plurality of components of interest, thus a “panel” of components of interest (hereinafter “POCI”), are used in the invention. By use of such an endogenous gas the present invention realizes the advantage of shorter measurement times, because waiting for passage of the time of travel of the GCOI from the surface to the gas lift valves that pass it to the production tube is not required. Also, the inability of the prior art technique to “see” gas lift valves below the depth of a valve taking the most of the injected gas tracer into the production tube is remedied. The technique of the present invention also avoids the need to transport cylinders of an exogenous tracer gas, such a CO₂ or nitrogen, to remote locations for use.

Lift gas for a gas lift well is typically produced on site from gas drawn from a separator at the surface. Such lift gas is typically produced gas that has been “cleaned” to remove products undesirable in a commercial product of the produced gas or undesirable to reintroduce into a well bore. Among products that can be “undesirable to reintroduce into a well bore” are products that are saleable, such as methane.

A GCOI according to the invention can be any gas that is present among formation fluids that reach the surface through the production tube of the gas lift well (“produced fluids”). In some embodiments, GCOIs are substances that are present in the produced fluids, but are considered undesirable in commercial products to be obtained from the produced fluids. Preferred GCOI substances for use in the present invention, such as hydrogen sulfide (H₂S) or light hydrocarbon gases such as methane, ethane, propane, butanes and/or pentanes are easily separated from produced fluids. Helium, carbon dioxide or nitrogen are also gases found in formation fluids that might be used. Thus, the GCOI used in the present invention is easily identified among substances from the “waste” line of a separator placed at the output from the production tube. The GCOI in any event is a gaseous substance that is present in the fluids produced from the well, but absent from the lift gas used in the well. Furthermore, a plurality of GCOIs (“PCOI”) can be monitored together as the GCOI.

The invention is a method for monitoring performance of gas lift wells, in particular, the method provides a way to measure how much of lift gas flow into the production tube is provided by gas lift valves at any particular depth in the well. In an optimized operation, lift gas typically flows into the production tube only through a single gas valve. The method of the invention can also detect undesired leaks of lift gas into the production tube from the annulus, or losses of lift gas from the annulus to the borehole. The method of the invention can be used to detect the presence and depth of a leak from the production tubing to the annulus, or can be used to detect the presence of a leak from the annulus to the borehole.

“Gas A” is taken as the formation gas, which contains the GCOI substance, and “Gas B” as the lift gas that lacks the GCOI substance. The formation gas composition is taken to be characterized, and variation of its composition over time is preferably assessed so as to obtain information about how the amount of a selected GCOI substance changes over time. Preferably the amount of the GCOI substance is relatively constant with time. Gas B is taken as the lift gas, and is preferably produced at the well site by a step including removal of the GCOI substance from the formation gas (Gas A). In any event, Gas B lacks the GCOI substance in any significant amount in comparison to the amount present in Gas A. Gas B is characterized to obtain the baseline amount of the GCOI substance in it before it is injected into the annulus as the lift gas. Both of Gases A and B are produced up the production tube to the surface; Gas A coming from the formation and Gas B coming from a gas lift valve or from another point of gas communication between the annulus and the production tube.

The baseline amount of GCOI substance present in each of Gas A and Gas B can be periodically measured, and in some embodiments, these amounts are assessed just before the start of a test according to the present invention.

In the method of the invention, the output of the production tube is monitored with respect to concentration of the GCOI in the production fluids, preferably in the gas phase of the production fluids. This measurement provides a “baseline” amount of GCOI substance in the combination of Gases A and B. Then, the flow of lift gas (Gas B) through one or more gas lift valves is changed, e.g. by a change in the pressure of the injected gas, so that the relative concentration of production gas in the vicinity of one or more gas lift valves is changed. The pressure change moves down the annulus at the speed of sound, and so in a matter of seconds results in a “step” change in concentration of the GCOI substance in the vicinity of the gas lift valve(s). This region of changed local concentration of GCOI then moves up the production tube to the surface. A “slug” of changed local concentration of the GCOI is created when the perturbation of the lift gas flow through the lift gas valve is returned to normal. Such a slug will show a rise and fall in concentration of the GCOI versus time (or vice-versa) that can be predicted based upon the flow rate of the fluids in the production tube and the distance up the tube traveled by the slug. The profile of the change of the concentration of the GCOI versus time will also be affected by characteristics of the production tube that provide mixing of the fluids it contains along its length (e.g. wall friction, tube diameter). However, these mixing characteristics are taken as fixed for any particular well that is being assessed. In any event, the well can be characterized by nodal analysis, Flowing Pressure Traverses (FPTs), Production Logging Tests (PLTs) and other typical methods to measure or verify these characteristics.

Meanwhile, at the surface (or at any desired depth), the concentration of the GCOI substance in the fluids produced from the well is monitored over time. The concentration of the GCOI in the production fluids can be measured by methods usual in the art, such as gas chromatography or spectroscopic techniques. However, gas chromatographic methods suffer from slow data production. Mass spectroscopy is the preferred method for monitoring concentration of the GCOI, due to the rapid measurement provided by this technique. In instances where a PCOI is used, it might be desirable to separate the components of the production fluid from one another prior to measuring their concentrations. In such instances, gas chromatography/mass spectroscopy or tandem mass spectroscopy can be used. Preferred instruments for measuring the GCOI or PCOI in the production fluids are the THERMOSTAR and OMNISTAR mass spectrometers available from Pfeiffer Vacuum. These instruments are configured for gas analysis and incorporate a PRISMAPLUS mass spectrometer. Pfeiffer Vacuum also offers the HIQUAD mass spectrometer, a high resolution model. Data from these instruments can be easily analyzed for the information required to implement the method of the present invention using the QUADERA software offered with the instruments.

Preferably the mass spectrometer is run in a mode that produces only the “parent” or “molecular” ion; i.e. fragmentation of the molecules is nil or minimized during the analysis.

The present method is a “fingerprinting” technique, and so in instances where one or more peaks in gas chromatographic or mass spectrometric data are clearly resolved that can be assigned to the GCOI or to the PCOI against the background of other components of the production fluid, then it is not necessary to separate the GCOI or the various substances making up the PCOI from the other components of the production fluid prior to measuring the concentration of the GCOI or PCOI in the production fluid.

When the slug reaches the monitor, a change in the relative GCOI concentration in the produced fluid can be measured. For example, in an instance where the slug is created by abruptly increasing the amount of lift gas injected (e.g. by raising the injection pressure) for a short period of time, and then returning the lift gas flow to normal, the concentration of the GCOI substance detected at the surface will decrease abruptly, then return to normal after the slug has passed.

The method of the present invention works in the same manner, regardless of whether the gas lift valves are of the production pressure operated or injection pressure operated type. However, the responses of the system to changes in the casing pressure are expected to be smaller in magnitude when the invention is used with production pressure operated valves.

By measuring the total amount of lift gas added to the slug and comparing that to the dilution of the GCOI measured at the surface, a leak in the production tube can be detected as observation of a distorted GCOI concentration versus time profile. For instance, lift gas entering the production tube at a point above the tested valve, e.g. from a leak in the tubing wall or from a leaking gas lift valve, will result in detection of dilution of the GCOI at a time earlier than expected. On the other hand, observing expected timing of the change in concentration of GCOI, but less dilution of the GCOI substance than expected, points to introduction of less gas than expected; e.g. a leak of lift gas from the annulus into the borehole or formation, or a plugging of a gas lift valve.

The invention can thus be considered in one aspect as a method for determining the depth of entry of lift gas into a production tube of a gas lift well, comprising determining the concentration of a GCOI, which is endogenous to a formation gas produced from the production tube of a gas lift well and absent from gas used as the lift gas in said gas lift well, versus time after a perturbation of the rate of introduction of said lift gas into said production tube via one or more gas lift valves.

In another aspect, the invention can be considered as a method for determining the presence or absence of a leak in a gas lift well between the production tube and the annulus, comprising:
i) determining at a depth d0 (which can be the surface) the concentration of a GCOI in fluids produced from the production tube of a gas lift well, said GCOI being endogenous to gas present in a formation tapped by said gas lift well and absent from gas used as the lift gas in said gas lift well, versus time after a perturbation of the rate of introduction of said lift gas into said production tube via a gas lift valve located at a depth d1 to measure a time t1 when the concentration of GCOI changes from the concentration before the perturbation;
ii) comparing the time t1 with the time t0 obtained by calculation of the time expected for a unit of gas volume to move from depth d1 to depth d0;
wherein t1<t0 indicates a leak between the annulus and the production tube at some depth above d1.

In another aspect, the invention can be considered as a method for determining the presence or absence of a leak in a gas lift well between the annulus and the borehole or formation, comprising:
i) determining at a depth d0 the concentration of a GCOI in fluids produced from the production tube of a gas lift well, said GCOI being endogenous to a gas present in a formation tapped by said gas lift well and absent from gas used as the lift gas in said gas lift well, versus time after a perturbation of the rate of introduction of said lift gas into said production tube via a gas lift valve to measure a maximum change in concentration ΔCmax of said GCOI over the interval from the time of the perturbation to a time t1 that is the expected time of transit of a unit volume of gas from said gas lift valve to depth d0;
ii) comparing the value of ΔCmax measured to the ΔCmax expected (Δconc) as calculated by the change in the amount of lift gas introduced into the production tube in said perturbation,
wherein a value of measured ΔCmax below the expected value of ΔCmax indicates the presence of a leak of lift gas from the annulus to the borehole or formation.

In some embodiments of any aspect of the invention, the GCOI is a light hydrocarbon gas, such as methane, ethane, propane, n-butane or a mixture of butanes, or n-pentane or a mixture of pentanes. In some embodiments of any aspect of the invention, the GCOI is a non-hydrocarbon gas, such as helium, hydrogen sulfide (H₂S), carbon dioxide or nitrogen that is found naturally in formation fluids. In some embodiments of any aspect of the invention, the GCOI is a plurality of gaseous components (POCI) endogenous to the formation fluids.

In some embodiments of any aspect of the invention, the POCI is a mixture of hydrogen sulfide and at least one of methane, ethane or propane.

In some embodiments of any aspect of the invention, the POCI is a mixture of hydrogen sulfide and carbon dioxide or nitrogen, or a mixture of hydrogen sulfide, carbon dioxide and nitrogen.

In some embodiments of any aspect of the invention, the perturbation of lift gas flow is temporary increase in lift gas injection rate.

In some embodiments of any aspect of the invention, the perturbation of lift gas flow is temporary decrease in lift gas injection rate.

In some embodiments of any aspect of the invention, the concentration of GCOI is measured by gas chromatography or mass spectroscopy.

In some embodiments of any aspect of the invention, the concentration of GCOI is measured by gas chromatography/mass spectroscopy.

In some embodiments of any aspect of the invention, the concentration of GCOI is measured by tandem mass spectroscopy.

The technique of the present invention eliminates the need for pressurized tracer bottles in the field, as the “tracer” is already in the gas lift and/or produced gas. The long wait time for a tracer slug to travel down the annulus to a gas lift valve—estimated at 95% of total round-trip time in CO₂ tracing—is avoided. Multiple tests could be performed in a short time to verify results. An accurate knowledge of the gas lift gas injection rate is unnecessary since the produced liquid velocity would be the primary variable affecting the transit time of interest. Finally, an upper valve would not be able to monopolize test results as each valve would be subjected to the same gas lift gas.

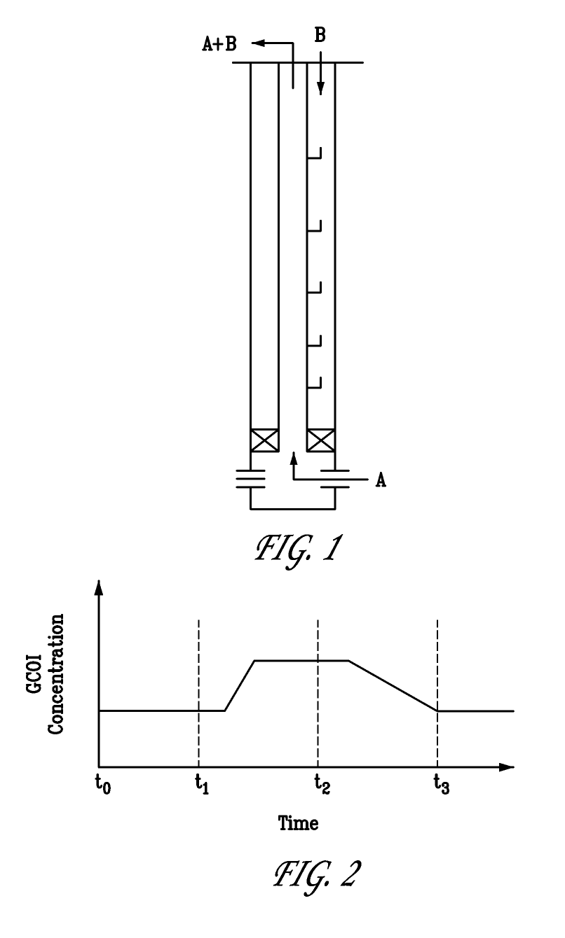

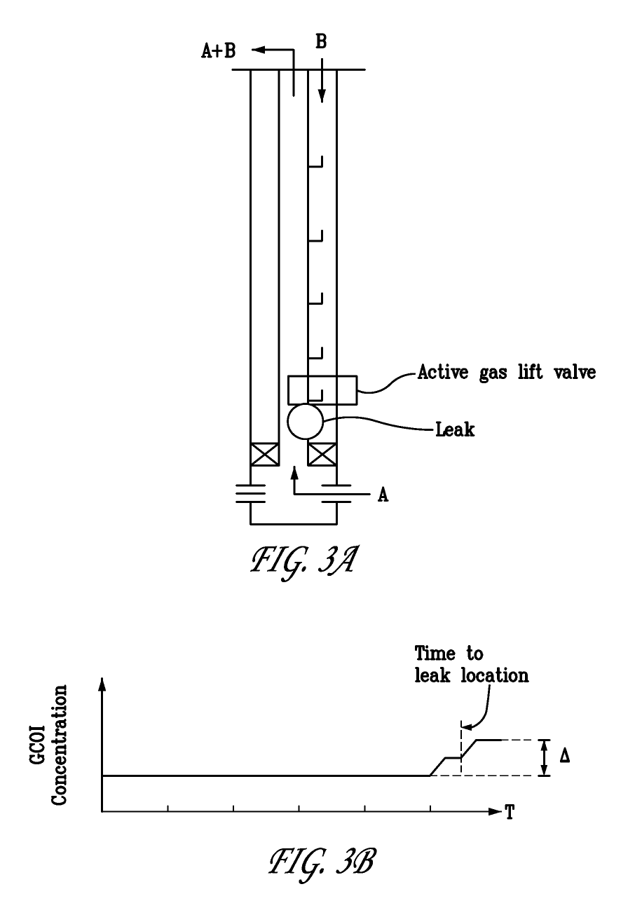

FIGS. 1 and 2 describe a basic application of the proposed technology. Gas A is sourced from the producing formation along with the target hydrocarbons (and accompanying liquids). Gas B is injected lift gas. Gases A and B are produced up the tubing to the surface. Gas B may be Gas A that has been processed to separate hydrocarbons or remove (or reduce) some contaminants that could harm the well and/or the equipment in it. In this example, assume that Gas A has the GCOI (additional) component and Gas B does not. The fingerprinting device would first measure the Gas B composition as it is injected into the casing. The device would then be moved to the production tubing to measure the combination of Gases A and B.

Referring to FIG. 2, at time t₀, the well is at steady state, and the GCOI has a given concentration. At t₁, a system upset is made. In this example, the gas lift gas (Gas B) volumetric rate is reduced. Since Gas B does not have the GCOI, its presence effectively “dilutes” the GCOI concentration in the Gas A+B combination. Thus a reduction in gas lift injection rate causes the GCOI concentration measured at surface to increase to a new equilibrium level. The delay from system change to measured concentration increase along with the calculated production tubing transit time can be used to determine points of lift gas entry into the production tube. The time between changes in the slope of the trace of GCOI concentration vs. time should correspond to the distance between points of entry of lift gas into the production tube. The degree of slope change, i.e. the height of each step change in GCOI concentration, may reflect the amount of gas introduced at each point of entry. At t₂, the gas lift rate is increased to its original value. After another delay—which could be used to validate the first test—the GCOI concentration begins its decrease back to steady-state operation (t₃).

In the example illustrated by FIGS. 1 and 2, there is only a single working lift gas valve at the bottom of the well. This is a typical situation for a producing gas-lifted well. Also, in this instance, there are no leaks to be observed between the production tube and the annulus, or between the annulus and the borehole. Thus, the trace of GCOI concentration vs. time (FIG. 2) shows a single rise in slope at the expected time of travel of gas from the depth of the working lift gas valve to the surface, and a single step returning to the original steady state when the perturbation is ended.

In general, the perturbation of the gas lift injection rate can be either an increase in the rate of injection or a decrease in the rate of injection. Generally, the maximum change in GCOI concentration (Δconc) is expected to reflect the overall change in the rate of lift gas injection into the annulus during the perturbation, and the area under the curve of Δconc×time is expected to reflect the total change in the amount of lift gas injected during the test.

Considerations for calculating an expected time of travel of lift gas, as either a gas phase or as a mixed liquid/gas phase are disclosed in, e.g. U.S. Pat. No. 8,150,637, hereby incorporated by reference.

The boundaries of the change in lift gas injection pressure are governed by the valve opening pressure at depth of the lift gas valve to be tested (this will be the bottom-most valve in most operations, as it is typically the only operating lift gas valve in a producing well after unloading), and the opening pressure at depth of the lift gas valves proximately above and below the valve being tested. If the change in injection pressure exceeds the valve opening pressure set for the valve above the tested valve, that proximately shallower valve will open, with the resulting change in the expected time of detection of the change in CGOI concentration at the surface, and a decrease in the size of concentration steps observed proportional to the part of the lift gas directed to the production tube through that shallower, now open, gas lift valve. (However, the overall maximum change in concentration will be the same for the same change in total amount of lift gas injected.) Of course, this approach can be used to check the opening operation of that next shallower valve if that is desired.

In another embodiment of the invention, a system or kit for gas lift well surveillance includes components for evaluating the performance of a gas lift well. Such components include a separator, a device for characterizing both the lift gas and the gas phase of the fluids produced from the well to determine what substances can be used as the GCOI and/or to quantitate the GCOI during operation of the system in a diagnostic test, optionally a device for sensing and measuring pressure and temperature, a device for flow control and pressure regulation to sample the lift gas and fluids produced from the well and to direct them to the device for their characterization and quantitation of the GCOI, a device for collecting and storing data, and optionally a computer program for evaluating the performance of the gas lift well embodied on a computer-readable medium. In some embodiments the system is configured so that the device for data collection and storage is triggered to begin data collection and storage upon sensing a pre-determined change in pressure of lift gas injection into the annulus of the gas lift well. In some embodiments, a device for measuring pressure of casing and production tubing at the surface is helpful to better detect/quantitate the perturbation time and predict the response time. A temperature sensor at the surface may be useful for converting gas volumes to standard conditions of temperature and pressure so as to improve accounting of the amount of the lift gas injected.

As explained above, a device for characterizing the lift gas and the gas phase of the fluids produced from the well to determine a suitable GCOI or PCOI and for quantitating said GCOI or PCOI during the performance of the method of the invention is preferably a mass spectrometer.

A device for collecting and storing data generated in the method of the invention can be a suitably programmed computer, especially a volatile or (preferably) non-volatile memory device. A printer/plotter can also be used to record and display data collected during implementation of the method of the invention.

Devices for flow control and pressure regulation to sample the lift gas and fluids produced from the well and to direct them to the device for their characterization and quantitation of the GCOI can be any of those that are well-known in the art.

Since the described system requires no injection of tracer and less time for diagnostics than existing techniques, it could operate as a permanent installation in a gas-lifted facility. For example, a composition measuring device could be placed at a centralized point such as a test separator. The measuring device could be used to periodically verify the composition of the gas lift gas and could sample the composition of any single well flowing to that centralized location. Gas lift performance of a given well or production tube could be characterized simply by creating an upset in the gas lift supply to that particular well. Multiple wells could be tested in a relatively short timeframe, allowing for more frequent gas lift diagnostics, optimization, and associated production improvement.

All or a portion of the methods, systems and subsystems of the exemplary embodiments can be conveniently implemented using one or more general purpose computer systems, microprocessors, digital signal processors, microcontrollers, and the like, programmed according to the teachings of the exemplary embodiments disclosed herein, as will be appreciated by those skilled in the computer and software arts.

Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web or any other network environment. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments disclosed herein can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of a form disclosed herein for performing all or a portion (if processing is distributed) of the processing performed in implementing the methods disclosed herein. Computer code devices of the exemplary embodiments disclosed herein can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments disclosed herein can be distributed for better performance, reliability, cost, and the like.

As stated above, the methods, systems, and subsystems of the exemplary embodiments can include computer readable medium or memories for holding instructions programmed according to the embodiments disclosed herein and for holding data structures, tables, records, and/or other data described herein. Computer readable medium can include any suitable medium that participates in providing instructions to a processor for execution. Such a medium can take many embodiments, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common embodiments of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium that a computer can read.

Another embodiment of the invention is a computer-readable medium storing a computer program for evaluating the performance of a gas lift well. The gas lift well includes a well casing, an annulus formed between the well casing and one or more production tubes, the annulus including a lift gas, and the production tubing containing production fluids, which in turn may also include lift gas, and one or more determined points of communication between the annulus and the production tubing, each of the one or more determined points of communication corresponding to a gas lift valve position. The computer program includes instructions for: i) assigning a signal from the device for characterizing or quantitating the GCOI, such as a signal of a molecular ion of a gaseous substance, as a signal to be monitored, ii) measuring, over a period of time, a concentration of the GCOI present in fluids retrieved from the production tubing, iii) determining one or more actual travel times of the GCOI based on a change of the concentration of the GCOI measured over the period of time from the baseline GCOI concentration, each of the one or more actual travel times of the GCOI corresponding to a point of entry of one or more points of entry of the lift gas into the production tubing, iv) segmenting the gas lift well into a plurality of ranges of well depth, v) determining the proportion of lift gas entering the production tubing at each point of entry, vi) calculating a velocity of the lift gas in the production tubing for each of the plurality of ranges of well depth based on the proportion of lift gas introduced at each determined point of communication between the annulus and the production tubing, and vii) determining one or more points of entry of the lift gas into the production tubing based on: (a) the one or more actual travel times of the GCOI observed, and (b) the velocity of the mixture of production fluids and lift gas in the production tubing that is calculated for each of the plurality of ranges of well depth.

In some embodiments, it is not necessary to segment the gas lift well into a plurality of ranges of well depth, and instead, an average velocity of the mixture of production fluids and lift gas along the length of the production tubing can be used.

In one or more of the previously disclosed embodiments, the one or more determined points of entry of the lift gas may be compared to the one or more points of communication in order to determine, for each of the one or more determined points of entry of the lift gas, whether the point of entry corresponds to a leak of the lift gas into the production tubing or entry of the lift gas into the production tubing through a gas lift valve.

In one or more of the embodiments of the invention, an expected travel time of the GCOI may be calculated for each of the one or more points of communication between the annulus and the production tubing based on the velocity of the mixture of production fluids and lift gas in the production tubing calculated for each of a plurality of ranges of well depth. In some embodiments, it is not necessary to segment the gas lift well into a plurality of ranges of well depth, and instead, an expected travel time of the GCOI can be calculated from an average velocity of the mixture of production fluids and lift gas along the length of the production tubing. Further, a graphical representation of the concentration of the GCOI measured over a period of time, especially from a time just before the perturbation of the gas lift injection rate to a time just after exit of the last portion of production fluids incorporating the change in gas lift injection, may be displayed on an output device. The graphical representation may also provide an indication of the expected travel time of the GCOI calculated for each of the one or more predetermined points of communication between the annulus and the production tubing, i.e. the location of each gas lift mandrel.

In one or more of the embodiments, the graphical representation may include one or more steps or peaks showing the change in the concentration of the GCOI measured over a period of time, each of the one of more steps or peaks corresponding to one of the one or more actual travel times of the GCOI from its point(s) of entry into the production tube. Further, mass balance of the GCOI may be determined by: (i) determining an area under each of the one or more steps or peaks, (ii) summing each area determined for each of the one or more steps or peaks to obtain a total area, and (iii) determining, for each of the one or more steps or peaks, a ratio of the area under the each of the one or more steps or peaks to the total area, the ratio representing the proportion of the lift gas entering the production tube at the corresponding point of entry to the total amount of lift gas entering the production tube from all points of entry.

An expected mass balance for the GCOI during performance of the present method can be calculated from the change in the volume of lift gas injected from the change in injection pressure. Supposing that temperature throughout the well does not change during the implementation of the method, the change in the volume of lift gas injected per unit time will be proportional to the change in injection pressure. Consequently, the overall change in GCOI concentration will also be proportional to the change in injection pressure and an expected area under the curve of Δconc×time can be calculated. Observing a smaller integrated area under the curve of Δconc×time indicates a loss of lift gas from the annulus to the formation or to the borehole.

In the instance of multiple production tubes within a common annulus, such a result observed for one production tube could also indicate more lift gas than expected is going into another of the production tubes within the common annulus. In this case, the mass balance among all of the production tubes in the common annulus must be accounted for to determine if there is a leak from the annulus to the borehole or formation. Thus, a graphical representation indicating the concentration of the GCOI measured over the period of time may be provided for each production tube in a multiple completion gas lift well. An area under the curve of Δconc×time may be determined for each step or peak in each graphical representation. An area under each step or peak for each graphical representation is determined and the areas are summed to yield a total area. Then, the proportion of lift gas entering each point of entry can be determined from each peak, which corresponds to a ratio of the area under the peak to the total area under all peaks for all graphical representations. In determining the lift gas parameter for a particular peak it is necessary to sum the areas of all peaks included in all graphical representations because lift gas is injected into a common annulus in a multiple completion well and enters the two or more production tubings from the common annulus.

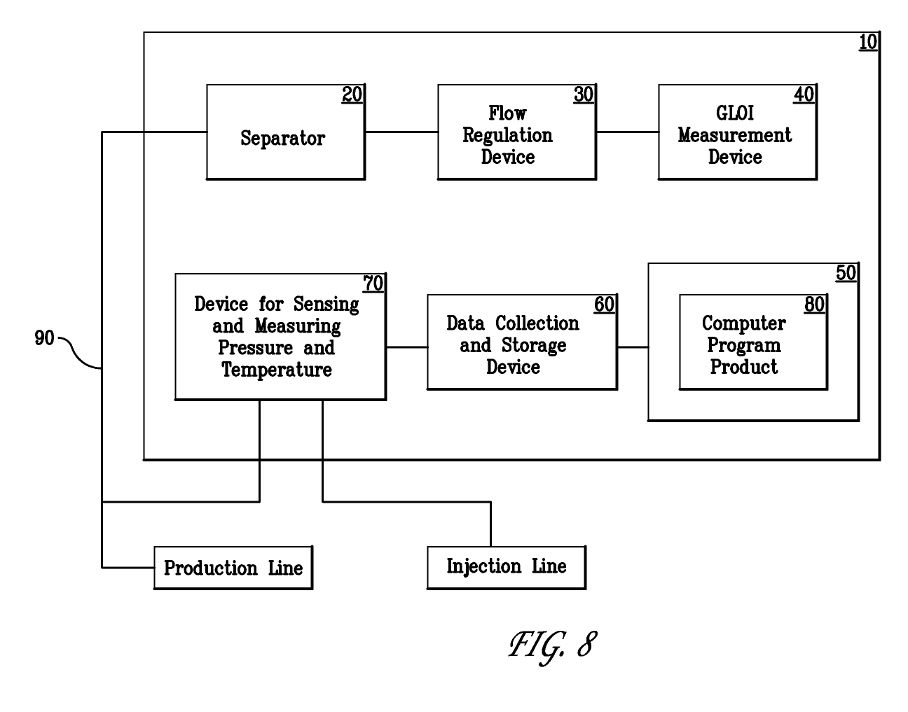

FIG. 8 depicts a gas lift well surveillance kit 10 in accordance with one or more embodiments of the invention. The kit 10 includes components for evaluating the performance of a gas lift well. The components include a separator 20, a flow regulation device 30, a GCOI measurement device 40, a data collection and storage device 60, a device for sensing and measuring pressure and temperature 70, and a computer program product 80 embodied on a computer-readable medium.

The separator 20 is configured to separate a gaseous phase from other phases that may be present in a mixture retrieved from a production reservoir via production tubing. Fluid that is retrieved from a production reservoir may include solid particles such as pieces of the rock formation. Also, in addition to lift gas that is present in the annulus of a well and that may have entered the production tubing, other gases present in the reservoir and/or rock formation may be present in the retrieved mixture. In addition, various liquids, including a desired production liquid, may be present in the retrieved mixture.

The separator can in some instances be the wellhead itself. For example, the gaseous components of the production fluids can be pulled from the crown valve at the top of the wellhead, while the majority of the liquids pass down the flow line. A filter can be located downstream of the crown valve, perhaps as a part of the measurement device at its input, to prevent liquid carryover from damaging or clogging the measurement device 40.

In one or more embodiments of the invention, a sample stream 90 is removed from a production stream that may include a multi-phase mixture retrieved from the reservoir through the production tubing. The sample stream 90 is removed from the production stream through a connection to the production line. The separator 20 may act on the sample stream 90 to separate a gaseous phase from other phases present in the mixture retrieved from the reservoir. After the separator 20 separates out the gaseous phase from the sample stream 90, the gaseous phase travels through the flow regulation device 30 which controls a flow rate of the gaseous phase into the GCOI measurement device 40.

The GCOI measurement device 40 continuously monitors and analyzes the gaseous phase for the presence of a GCOI. The gaseous phase may include a mixture of one or more gases.

The computer program product 80 embodied on the computer-readable medium is configured to analyze test data acquired by the data collection and storage device 60 during a well test. The computer program product 80 is configured to provide gas lift analysis, design, prediction and optimization using one or more of the following techniques: complex injection pressure models to determine velocities in the annulus, multi-phase pressure models to determine velocities in the production tubing, and well history data for comparison over time and archiving. The data collection and storage device 60 may be a datalogger, or any other data collection and storage device known in the art. The computer program product 80 is configured to analyze the test data and provide a highly accurate assessment of the presence and depths of one or more points of entry of a lift gas into production tubing. The computer program product 80 may be executed on a computing device 50, which may be a personal computer, at the site of testing and production. Although the computing device 50 is shown as an element of the kit 10, this is not required. That is, the computing device 50 may be provided separately from the kit 10.

Additionally, data acquired by the data collection and storage device 60 may be analyzed off-site. For example, the computing device 50 may include network communication means (not shown) for transmitting data to an off-site location. Alternatively, data collected by the data collection and storage device 60 may be transferred to another storage device (not shown) for analysis at a later time off-site. Further, the data collection and storage device 60 may be provided with a means to communicate with and transfer test data to the computing device 50 on which the computer program product 80 is being executed such that the computer program product 80 may perform analysis of the data. It is important to note that it is not necessary for the computing device 50 to be connected to the gas lift well surveillance kit 10, specifically the data collection and storage device 60, during testing and acquisition of test data. The computing device 50 may be connected to the gas lift well surveillance kit 10 after testing is complete as data acquired by the data collection and storage device 60 can be retrieved and analyzed at a later time by the computing device 50. After data acquired by the data collection and storage device 60 during a test is analyzed and interpreted, the data may be erased (i.e. the data collection and storage device 60 may be reset) in order to perform additional tests.

In one or more embodiments of the invention, the device for sensing and measuring pressure and temperature 70 may be a pressure/temperature transducer. The device for sensing and measuring pressure and temperature 70 may be utilized to sense and measure temperature and pressure within the sample stream 90 as well as within an injection line through which the lift gas is injected into the annulus of the gas lift well via a connection to the injection line.

In one or more embodiments of the invention, the gas lift well surveillance kit 10 may further include at least one power source, at least one analog pressure gauge, and piping or tubing for connecting the gas lift well surveillance kit to a gas lift well. In some embodiments, the lift gas can be metered in real time with an inline meter, such as a Coriolis or orifice plate meter, at the gas lift header. Another alternative is a “clamp-on” ultrasonic meter that uses a transducer clamped onto the pipe to determine the velocity of gas flowing through it. The velocity can then be converted to conditions of standard temperature and pressure to determine the amount of gas flowing through the pipe. Further, in one or more embodiments of the invention, the gas lift well surveillance kit 10 requires only one temporary connection point on the lift gas injection line and one connection point on the production line.

The computer program product (FIG. 8, 80) that is included in a gas lift well surveillance kit in accordance with one or more embodiments of the invention is configured to implement one or more of the previously described methods of the invention. For example, the computer program product includes instructions for calculating production fluid velocities in the production tubing using one or more complex models. The computer program product includes instructions for storing annulus and production tubing parameters (also known as tubing string and casing string information) and using one or more of these parameters to determine lift gas volume in the annulus and production fluid velocities in the production tubing. Production fluid velocities in the production tubing may be calculated using a multiphase flow pressure model that includes various parameters related to the flow of gas in a multi-phase mixture. The computer program product may further include one or more user interface screens that provide a user with access to data and models. One or more graphs for studying the relationship between various parameters may be displayed through the one or more user interface screens. For example, the graphical representation of GCOI concentration as a function of time has already been mentioned. Plots or graphs indicating the relationship between the following parameters may also be displayed. Examples of such plots include, but are not limited to, depth vs. pressure, depth vs. temperature, pressure vs. production, historical real-time data (for any parameter) v. time, pressure v. time, flow rates v. time, and production tube pressure v. lift gas injection pressure.

In a preferred embodiment, the computer readable medium of the invention is a non-volatile computer readable medium comprising instructions for specifically programming a computer to:
i) instruct a data collection and storage device to collect data of concentration of a GCOI in production fluids collected from the production tubing of a gas lift well, the gas lift well including an annulus, one or more production tubes, and one or more gas lift valves connecting the annulus and the one or more production tubes, under a condition of a first lift gas injection pressure;
ii) collect data of concentration of a GCOI in production fluids collected from the production tubing of said gas lift well over time after a time t0 at which the pressure of injection of lift gas into said annulus of the gas lift well is changed; and
iii) display the data collected in ii) as a plot of GCOI concentration vs. time or as a table of GCOI concentration vs. time.

In another embodiment, the computer readable medium of the invention further comprises:
iv) instructions to calculate the velocity of fluids in the production tubing of said gas lift well;
v) data of the depth of said one or more gas lift valves in the gas lift well; and
vi) instructions for displaying the time of transit of production fluids from the depth of said one or more gas lift valves to the site of said data collection and storage device on the plot of GCOI concentration vs. time or in the table of GCOI concentration vs. time.

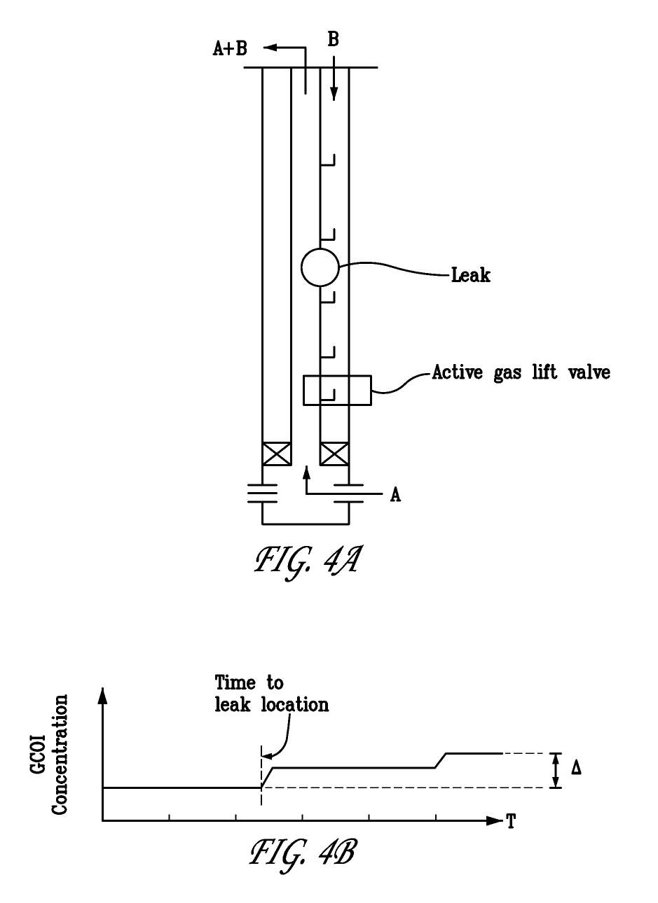

Several specific leak scenarios that can be detected by the present invention, and the expected traces of GCOI concentration versus time after perturbation of the lift gas injection rate for each, are illustrated in FIGS. 3-12. The expected traces of GCOI concentration versus time after perturbation are based on the premises 1) that the measurement of GCOI concentration in the produced fluids are measured at the surface, 2) that the perturbation is an temporary decrease in the volume of lift gas injected into the annulus (thus resulting in a temporary increase in GCOI concentration), and 3) that the illustrated leaks pass approximately the same amount of lift gas as each other and the working gas lift valve. A further assumption of the scenarios presented is that the only “working” gas lift valve in the well is the bottom-most gas lift valve. In the FIGS. 2 and 3B-12B, the time axis is marked by “gas lift valve number” showing the time that a volume of lift gas is expected to take to reach the surface from each gas lift valve in a situation where no leaks are present.

FIG. 3A illustrates leak scenario 1 detectable by the invention in which a leak between the production tube and the casing annulus is present below the working gas lift valve. FIG. 3B shows a GCOI concentration profile vs. time after perturbation that is suggestive of the scenario 1 shown in FIG. 3A. The profile shows a step increase in GCOI concentration at the expected time of transit of production fluids from the working gas lift valve to the surface (i.e. at GLV#5), but only approximately ½ the step height shown in FIG. 2, which is the value expected from the change in lift gas injection rate applied where no leak is present. Then, at a time somewhat greater than GLV#5, a second step in GCOI concentration is observed, the total of Δconc then reaching the value expected from the change in lift gas injection rate applied.

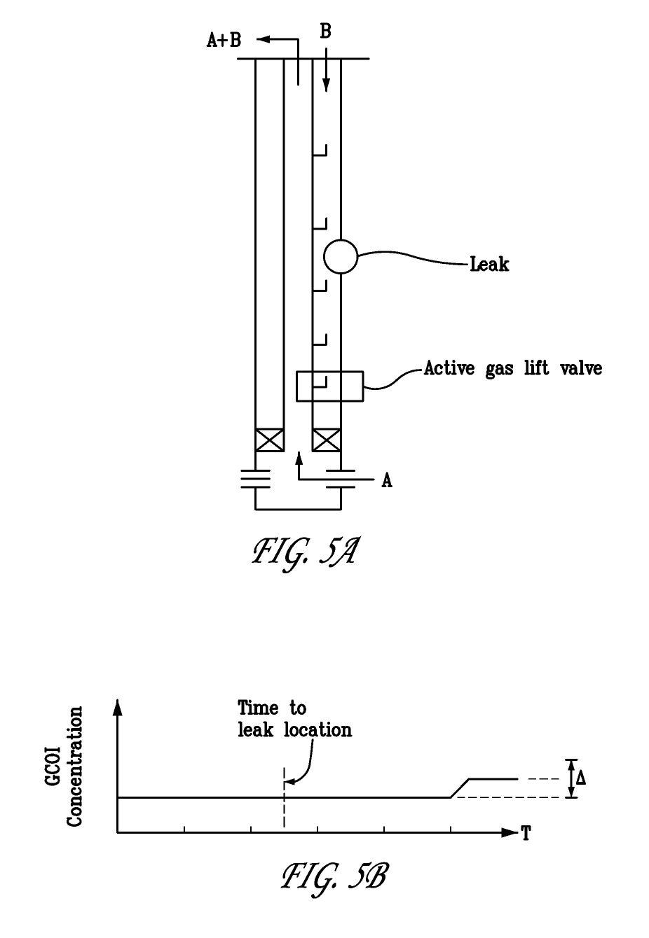

FIG. 4A is an illustration of leak scenario 2 detectable by the invention in which a leak between the production tube and the casing annulus is present above the working gas lift valve, between lift gas valves #2 and #3. FIG. 4B is an illustration of a GCOI concentration profile vs. time after perturbation that is suggestive of the scenario 2 shown in FIG. 4A. In this instance a step in GCOI concentration is observed at time between GLV#2 and GLV#3 and again having a height approximately ½ that of the Δconc overall. At time GLV#5 a second step in GCOI concentration is observed, again of ½ that of the Δconc overall, bringing the total height of the change in GCOI concentration to the expected level.

FIG. 5A is an illustration of leak scenario 3 detectable by the invention in which a leak between the casing annulus and the borehole is present above the working gas lift valve between lift gas valves #2 and #3. FIG. 5B is an illustration of a GCOI concentration profile vs. time after perturbation that is expected to be observed for the scenario 3 shown in FIG. 5A. In this instance, there is a step increase in GCOI concentration at time GLV#5, as expected, but the height of the step is only ½ the height expected for Δconc overall, since about ½ of the lift gas will leak to the formation and not be available to dilute the formation gas in the production tube. The depth of the leak is not discernible from these data alone.

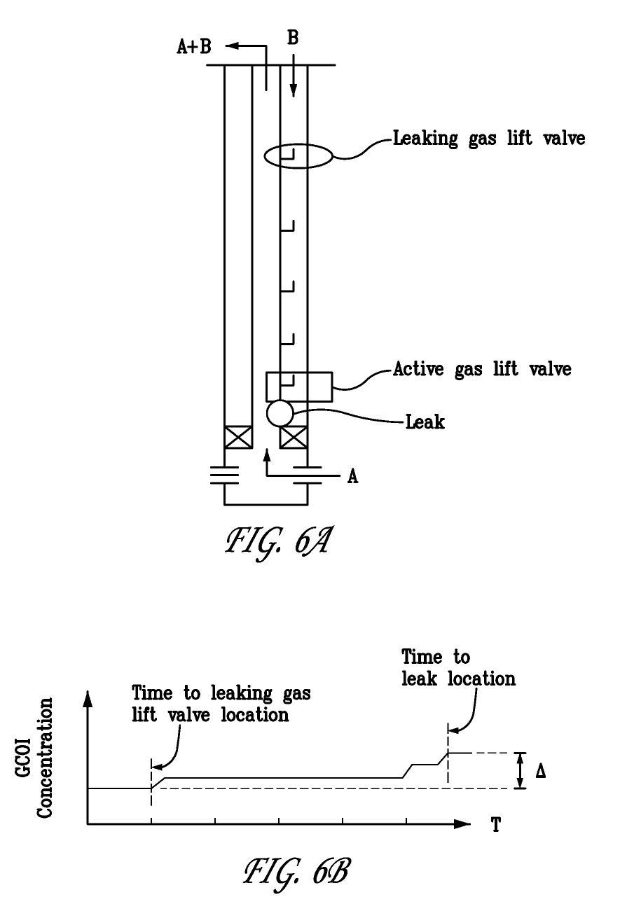

FIG. 6A is an illustration of leak scenario 4 detectable by the invention in which a leak between the production tube and the casing annulus is present below the working gas lift valve and a leaking gas lift valve (#1) is above the working gas lift valve. FIG. 6B is an illustration of a GCOI concentration profile vs. time after perturbation that is expected to be observed in the leak scenario 4 shown in FIG. 6A. In this instance, there is a step in GCOI concentration at time GLV#1. Under the assumptions above, GLV#1 is passing an amount of injection gas equal to the amount passed by the working valve GLV#5 and also equal to the amount of the leak between the annulus and the production tube. Thus, the step in GCOI concentration at time GLV#1 is ⅓ the expected height overall. A second step, also of ⅓ the expected height, is seen at time GLV#5 and a third such step is seen at a time somewhat greater than GLV#5.

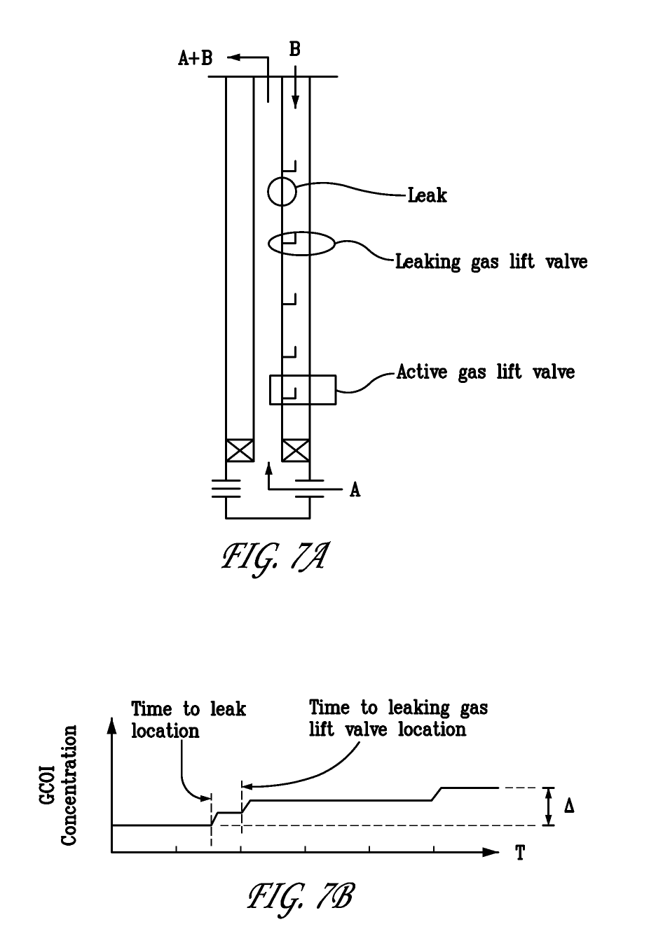

FIG. 7A is an illustration of a leak scenario 5 detectable by the invention in which a leak between the production tube and the casing annulus (between gas lift valves #1 and #2) and a leaking gas lift valve (#2) are both present above the working gas lift valve. FIG. 7B is an illustration of a GCOI concentration profile vs. time after perturbation that is expected for the scenario 5 shown in FIG. 7A. In this instance, a step of ⅓ the expected height is seen between GLV#1 and GLV#2 and a second such step is seen at time GLV #2. A final step of ⅓ height is seen at GLV#5.

The embodiments disclosed herein, as illustratively described and exemplified hereinabove, have several beneficial and advantageous aspects, characteristics, and features. The embodiments disclosed herein successfully address and overcome shortcomings and limitations, and widen the scope, of currently known teachings with respect to removing liquids from gas-lifted wells.

Illustrative, non-exclusive examples of apparatus and methods according to the present disclosure are presented above. It is within the scope of the present disclosure that an individual step of a method recited herein, including in the following enumerated paragraphs, may additionally or alternatively be referred to as a “step for” performing the recited action.

### INDUSTRIAL APPLICABILITY

The apparatus and methods disclosed herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A method for determining the depth of entry of lift gas into a production tube of a gas lift well, the gas lift well including a casing annulus including a lift gas, one or more production tubes including production fluids and surrounded by the casing annulus, and gas lift valves providing for entry of lift gas from the annulus to the production tube(s), comprising determining the concentration of a GCOI endogenous to a formation gas produced from the production tube of a gas lift well and absent from gas used as the lift gas in said gas lift well versus time after a perturbation of the rate of introduction of said lift gas into said production tube via one or more gas lift valves.

2. The method of claim 1, wherein the GCOI is H₂S, nitrogen, carbon dioxide, methane, ethane or propane.

3. The method of claim 1, wherein the GCOI is a POCI, and the POCI is a mixture of hydrogen sulfide and at least one of methane, ethane or propane.

4. The method of claim 3, wherein, the POCI is a mixture of hydrogen sulfide and carbon dioxide or nitrogen, or a mixture of hydrogen sulfide, carbon dioxide and nitrogen.

5. The method of claim 1, wherein the perturbation is an increase in the rate of introduction of lift gas into the production tube.

6. The method of claim 1, wherein the perturbation is a decrease in the rate of introduction of lift gas into the production tube.

7. The method of claim 1, wherein the GCOI concentration is measured by gas chromatography, mass spectroscopy or gas chromatography/mass spectroscopy.

8. The method of claim 1, further comprising a step of measuring the amount of GCOI in the formation gas and in the lift gas prior to perturbing the rate of introduction of lift gas into the production tube.

9. A method for determining in a gas lift well, the gas lift well including a casing annulus including a lift gas, one or more production tubes including production fluids and surrounded by the casing annulus, and gas lift valves providing for entry of lift gas from the annulus to the production tube(s), the presence of a leak between the production tube and the annulus, comprising:
i) determining at a depth d0 the concentration of a GCOI in fluids produced from the production tube of a gas lift well, said GCOI being endogenous to a gas present in a formation tapped by said gas lift well and absent from gas used as the lift gas in said gas lift well, versus time after a perturbation of the rate of introduction of said lift gas into said production tube via a gas lift valve located at a depth d1 to measure a time t1 when the concentration of GCOI changes from the concentration before the perturbation;
ii) comparing the time t1 with the time t0 obtained by calculation of the time expected for a unit of gas volume to move from depth d1 to depth d0;
wherein t1<t0 indicates a leak between the production tube and the annulus at some depth above d1.

10. The method of claim 9, wherein the GCOI is H₂S, nitrogen, carbon dioxide, methane, ethane or propane.

11. The method of claim 9, wherein the GCOI is a POCI, and the POCI is a mixture of hydrogen sulfide and at least one of methane, ethane or propane.

12. The method of claim 11, wherein, the POCI is a mixture of hydrogen sulfide and carbon dioxide or nitrogen, or a mixture of hydrogen sulfide, carbon dioxide and nitrogen.

13. The method of claim 9, wherein the perturbation is an increase in the rate of introduction of lift gas into the production tube.

14. The method of claim 9, wherein the perturbation is a decrease in the rate of introduction of lift gas into the production tube.

15. The method of claim 9, wherein the GCOI concentration is measured by gas chromatography, mass spectroscopy or gas chromatography/mass spectroscopy.

16. The method of claim 9, further comprising a step of measuring the amount of GCOI in the formation gas and in the lift gas prior to perturbing the rate of introduction of lift gas into the production tube.

17. A method for determining in a gas lift well, the gas lift well including a casing annulus including a lift gas, one or more production tubes including production fluids and surrounded by the casing annulus, and gas lift valves providing for entry of lift gas from the annulus to the production tube(s), the presence or absence of a leak between the annulus and the borehole or formation, comprising:
i) determining at a depth d0 the concentration of a GCOI in fluids produced from the production tube of said gas lift well, said GCOI being endogenous to a gas present in a formation tapped by said gas lift well and absent from gas used as the lift gas in said gas lift well, versus time after a perturbation of the rate of introduction of said lift gas into said production tube via a gas lift valve, to measure a maximum change in concentration ΔCmax of said GCOI over the interval from the time of the perturbation to a time t1 that is the expected time of transit of a unit volume of gas from said gas lift valve to depth d0;
ii) comparing the value of ΔCmax measured to the ΔCmax expected as calculated by the change in the amount of lift gas introduced into the production tube in said perturbation,
wherein a value of measured ΔCmax below the expected value of ΔCmax indicates the presence of a leak of lift gas from the annulus to the borehole or formation.

18. The method of claim 17, wherein the GCOI is H₂S, nitrogen, carbon dioxide, methane, ethane or propane.

19. The method of claim 17, wherein the GCOI is a POCI, and the POCI is a mixture of hydrogen sulfide and at least one of methane, ethane or propane.

20. The method of claim 19, wherein, the POCI is a mixture of hydrogen sulfide and carbon dioxide or nitrogen, or a mixture of hydrogen sulfide, carbon dioxide and nitrogen.

21. The method of claim 17, wherein the perturbation is an increase in the rate of introduction of lift gas into the production tube.

22. The method of claim 17, wherein the perturbation is a decrease in the rate of introduction of lift gas into the production tube.

23. The method of claim 17, wherein the GCOI concentration is measured by gas chromatography, mass spectroscopy or gas chromatography/mass spectroscopy.

24. The method of claim 17, further comprising a step of measuring the amount of GCOI in the formation gas and in the lift gas prior to perturbing the rate of introduction of lift gas into the production tube.

25. A system for evaluating the performance of a gas lift well, the gas lift well including an annulus, one or more production tubes, and one or more gas lift valves connecting the annulus and the one or more production tubes, said system comprising a separator, a flow regulation device, a measurement device for measuring over time the concentration of a GCOI in production fluids, a data collection and storage device for recording data from the measurement device, and a computer program product embodied on a computer-readable medium for analyzing the data collected by the measuring device.

26. The system of claim 25, in which the measurement device is a mass spectrometer.

27. The system of claim 25, in which the measurement device is a tandem mass spectrometer.

28. The system of claim 25, in which the measurement device is programmed to detect and quantitate concentrations of at least one of H₂S, nitrogen, carbon dioxide, methane, ethane or propane.

29. The system of claim 25, in which the measurement device is programmed to detect and quantitate concentrations of a mixture of hydrogen sulfide and carbon dioxide or nitrogen, or a mixture of hydrogen sulfide, carbon dioxide and nitrogen.

30. The system of claim 25 that further comprises a pressure sensor for measuring the pressure of lift gas injected into the annulus of the gas lift well and wherein the data collection and storage device can be triggered to begin data collection upon sensing a predetermined change in pressure of lift gas injection.

31. A non-volatile computer readable medium comprising instructions for specifically programming a computer to:
i) instruct a data collection and storage device to collect data of concentration of a GCOI in production fluids collected from the production tubing of a gas lift well, under a condition of a first lift gas injection pressure;
ii) collect data of concentration of a GCOI in production fluids collected from the production tubing of said gas lift well over time after a time t0 at which the pressure of injection of lift gas into said annulus of the gas lift well is changed;
iii) display the data collected in ii) as a plot of GCOI concentration vs. time or as a table of GCOI concentration vs. time.

32. The non-volatile computer readable medium of claim 31, that further comprises:
iv) instructions to calculate the velocity of fluids in the production tubing of said gas lift well;
v) data of the depth of said one or more gas lift valves in the gas lift well;
vi) instructions for displaying the time of transit of production fluids from the depth of said one or more gas lift valves to the site of said data collection and storage device on the plot of GCOI concentration vs. time or in the table of GCOI concentration vs. time.
